(19) United States
(12) Patent Application Publication
(10) Pub. No.: US 2009/0218041 A1
(43) Pub. Date: Sep. 3, 2009

(54) METHOD FOR MANUFACTURING A PORTABLE ELECTRONIC DEVICE HOUSING

(75) Inventors: Kenneth Dean, Phoenix, AZ (US); Bernard F. Coll, Fountain Hills, AZ (US); Allison M. Fisher, Chandler, AZ (US); Carl R. Hagen, Chandler, AZ (US); Michael Hupp, Gilbert, AZ (US); James E. Jaskie, Scottsdale, AZ (US); Scott V. Johnson, Scottsdale, AZ (US); Thomas Shellberg, Chandler, AZ (US); Stephen L. Spanoudis, Coral Springs, FL (US); Ryan M. Froyd, Sunrise, FL (US); Steven R. Young, Gilbert, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/040,268

(22) Filed: Feb. 29, 2008

(51) Int. Cl. C09J 5/00

(52) U.S. Cl. 156/305

(57) ABSTRACT

A method for forming a housing for an electronic device (510) includes providing a first rigid layer (102, 302) including a curved surface defining a cavity (108, 308). A first adhesive (112, 312) is optionally applied over the curved surface, and an electro-optic module (105, 305) having a flexible substrate and a viewable surface (111, 311), is conformally fitted on the first adhesive (112, 312). A second adhesive (114, 314) is optionally disposed over the electro-optic module (105, 305) and a support structure (122) is optionally placed on the second adhesive (114). The support structure (122) includes an attachment apparatus (126) for mounting electronic circuitry. The first and second adhesives (112, 114) are cured. One of the second adhesive (114) or both the first rigid layer (102, 301) and the first adhesive (112) are transparent for viewing a viewable surface (111, 311) on or coupled to the electro-optic module (105, 305).

### FIELD

The present invention generally relates to portable electronic devices and more particularly to a method and apparatus for changing the appearance of the portable electronic device housing.

### BACKGROUND

The market for electronic devices, especially personal portable electronic devices, for example, cell phones, personal digital assistants (PDA's), digital cameras, and music playback devices (MP3), is very competitive. Manufactures are constantly improving their product with each model in an attempt to cut costs and to meet production requirements.

The look and feel of personal portable electronics devices is now a key product differentiator and one of the most significant reasons that consumers choose specific models. From a business standpoint, outstanding designs (form and appearance) may increase market share and margin.

Consumers are enamored with appearance features that reflect personal style and select personal portable electronics devices for some of the same reasons that they select clothing styles, clothing colors, and fashion accessories. Consumers desire the ability to change the appearance of their portable electronics devices (cell phones, MP3 players, etc.). Plastic snap-on covers for devices such as cell phones and MP3 players can be purchased in pre-defined patterns and colors. These snap-on covers are quite popular, and yet they provide a limited customization capability. The types of electro-optical modules that one could affix or embed in a portable electronic device to enable a changing appearance are limited by a number of factors. Portable electronic devices must be particularly thin, robust, and low power. As high volume consumer products, their sales are very sensitive to consumer preferences for design, functionality, and cost. These factors produce a narrow engineering window requiring unique solutions.

Portable electronics devices have curved surfaces, both in-plane (organically-shaped) and out of plane. The out of plane curved surface often contains compound curves. It is desirable to incorporate electro-optical modules into housings with these shapes such that the modules cover as much surface as possible, including the curved surfaces. When curves are involved, optical adhesives tapes typically used for liquid crystal displays will not work. It is furthermore desirable to fabricate thin panels, on the order of a millimeter or less to form housing elements, so electro-optical modules will need to be very thin, and will be fabricated on thin plastic substrates. These modules will need to be protected, so it is furthermore desirable to protect the outer surface of the electro-optical modules with highly transparent, high optical quality material that is thick enough to prevent damage to the electro-optical module via scratches, abrasion, and drop-testing, yet is comparatively as thin as typical housings. Furthermore, the interior components of portable electronic devices are typically connected to the housing by attachment points formed by molding, stamping or insert-molded. It is desirable to add these attachment points to the electro-optical housing. Incorporating electro-optical modules into shoes, watches, automobile doors, eye wear and cellular phones has been published, but solutions for these critical features have not been described.

However, many portable devices have complex, curved surfaces, and organic shapes. Electro-optic modules with curves cannot simply be laminated within these portable devices using conventional LCD optical adhesive techniques. The prior art manufacturing methods do not provide a low temperature molding process which keeps the mold costs low. The lower temperature requirements for the substrates require very long (expensive) injection molding times, or thousands or re-useable molds for a batch process, which is also expensive. In addition, consumers desire small, thin devices, which would require the electro-optic modules to be fabricated on thin plastic substrates which are thin and damage-prone.

Accordingly, it is desirable to provide a color-changing surface which is an integral part of a portable electronics device, and to provide a method for fabricating this apparatus which utilizes high volume, low cost methods. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIGS. 1 and 2 are partial cross sectional views of a first exemplary embodiment during manufacture;

FIG. 3 is a partial cross sectional view of a second exemplary embodiment;

FIG. 4 is a flow chart of the manufacturing steps for the exemplary embodiment; and

FIGS. 5 and 6 are isometric views of a portable electronic device during different stages of operation in accordance with the exemplary embodiment of FIGS. 1 and 2.

### DETAILED DESCRIPTION

An appearance-adaptable portable electronics device, e.g., a chameleon skin device, includes an electro-optical module embedded into the housing of the portable electronics device, allowing the use of thin, flexible, organically-shaped electro-optic modules within curved surfaces, while providing protection from the environment. These electro-optic modules, also known as flexible displays, are manufactured by depositing electronic devices as a thin film of a few micrometers on a polymer or metal foil substrate. The housing containing the electro-optical module disclosed herein provides an injection-molded or similarly formed housing which has metal frame structures inset molded into the housing to act as structural supports and attachment points for internal electronic components.

The electro-optical module provides an additional means for a user to interact with their electronic device. It communicates with them by presenting colors, patterns, and/or graphic and textual information in a reflective mode. The housing may also act as a ‘smart skin’, receiving input from the environment such as user touch responses, and it may sense temperature, ultraviolet light, gases, and the like and respond accordingly.

The method and apparatus described herein is performed at a low enough temperature (low temperature molding process) to be compatible with optical grade transparent flexible substrates such as polyethylene terephthalate (PET) and polyethylene naphthalate (PEN), which tolerate about 150° C. for short periods of time. Their glass transition temperatures are 78° C. and 120° C. respectively, and melt below 260° C. Other transparent substrates also have low glass transition temperatures, for example, polycarbonate with a Tg of about 150° C. In contrast, known polycarbonate phone housings are processed at temperatures much higher than these, typically at temperatures greater than 300° C., and then rapidly cooled in order to speed up the injection mold time. The less time the injection molded part spends in the mold, the cheaper the finished part. While the parts are only at high temperature for 15-30 seconds typically, this would destroy devices built with PET and PEN substrates. In addition, injection molding typically produces very high shear forces, which can wrinkle thin substrates, especially at high temperatures.

The portable electronic device housing includes a transparent outer protective layer typically thicker than 50 micrometers, an electro-optical module, and a rear protective layer which may comprise attachment points for additional components. To produce thin housings, the electro-optical module is preferably manufactured on thin flexible substrates. The housings will typically have organic shapes such as ovals, rounded edges, or curves within the plane of the substrate sheets. They may also be conformed to a curved inner or outer protective layer, with these conformal curves being out of the plane of the substrate sheets. In a typical embodiment, the transparent outer protective layer defines at least one curve with a radius of curvature less than approximately 1.0 centimeter, and protects the electro-optical module from the environment, for example, puncture, scratches, water, and dirt, and is strong enough to withstand deep scratches and drops typically encountered with cell phone and MP3 player usage.

The method for manufacturing the electro-optical housing is compatible with the low temperature requirements of the flexible electro-optical module substrate material and a low enough cost for high volume manufacturing. Fabrication of the rigid shell, via injection molding or similar technique, is performed at a high temperature to increase the speed of the polymer injection and minimize the time in the mold. This shell then acts as a mold for lower temperature casting processes compatible with the electro-optical modules.

In order to avoid resin casting the modules into molds which would require thousands of molds for high volume portable electronics devices creating enormous tooling costs, the method of resin casting disclosed herein uses standard high temperature injection-molded (or metal insert-molded) parts, typically of polycarbonate to form the front protective layer or rear transparent layer. The transparent shell and support structure then act as a mold. The electro-optical module is low-temperature resin cast between them. Since molds are created for each part, they can be batch cured in an oven with no additional mold tooling needed. The resin casting approach provides an excellent method for assuring that the electrical input/output leads are accessible outside of the resin.

The following detailed description is merely exemplary in nature and is not intended to limit the invention or the application and uses of the invention. Furthermore, there is no intention to be bound by any theory presented in the preceding background or the following detailed description.

Referring to FIG. 1 and in accordance with a first exemplary embodiment, an outer protective, rigid layer, or shell, 102 is provided that preferably is injection-molded with a polycarbonate at a temperature, for example, greater than 300° C., but may be molded using other methods and may include insert-molded elements, particularly metal frames for structural support. Polycarbonate is a preferred material because it is robust and can be made inexpensively manufactured in high volume. In this embodiment, the rigid layer 102 is transparent in regions 103 so that the viewable surface 111 of the electro-optical module 105 can be viewed through the protective rigid layer 102, which will form the exterior of the housing. The sides 106 of the rigid layer 102 are out of plane with the rigid layer center 107, thereby forming a concave shape or cavity 108. As an example, FIG. 1 shows an essentially flat center region 107, with sidewalls 106 at the edge that define a cavity 108. The cavity 108 enables the rigid layer 102 to acts as the mold for curable adhesive or resin in later steps. The rigid layer 102 is molded to form a curvature between the center region 107 and sides 106 having a radius of less than approximately 1.0 centimeter.

In FIG. 1, the electro-optical module 105 is positioned, e.g, conformally fitted, over, and having its viewable surface 111 facing the protective layer 102, an adhesive 112 adhered to the outer protective layer 102. The electo-optical module 105 preferably is formed on a polymeric substrate and preferably comprises one of a cholesteric liquid crystal module, an electrowetting module, an electrochromic module, or an electrophoretic module for low power applications, or a polymer dispersed liquid crystal module or a twisted nematic liquid crystal module for higher power applications. The electro-optical module 105 has segmented or fully addressable regions (not shown) for displaying information in the preferred embodiment on the viewable surface 111. The electro-optical module 105 contains flexible substrates which create a very thin module suitable for housing. For cases where the electro-optical module 105 is to be positioned over curves in the rigid layer 102, the flexible substrates allow for the electro-optical module to be mechanically conformed to the curves in the rigid layer 102. Techniques for conforming the electro-optical module include simple placement, pushing into place with dies, and pushing into place with inflatable bags. Alternatively, the electro-optical module 105 may be thermoformed to the curvature of the rigid layer 102 during the when it is positioned, or it can already contain a curved profile. A touch screen (not shown) may be embedded between the transparent shell 102 and the electo-optical module 105.

The adhesive material 112, for example an optical adhesive, cast resin, or curable polymer is optionally deposited on the rigid layer 102 within the cavity 108 before placement of the electro-optic module 105 by a nozzle (not shown) or any appropriate method known in the industry. This adhesive 112 is optically transparent to provide visibility of the viewable surface 111, and preferably has high optical quality and a good refractive index match to the electro-optical module 105. High optical quality includes the absence of significant scattering, haze, optical attenuation, and unwanted color shift. Alternatively, the electro-optical module 105 may be vacuum-cast (in the next step) into the housing 102 without the adhesive 112. A vacuum removes the gas which would otherwise form bubbles between the rigid layer 102 and the electro-optical module 105, and the cast material holds the module in place.

Another adhesive material 114, for example, an optical adhesive, cast resin, or curable polymer, is deposited on the electro-optical module 105. Adhesive material 114 may be selected from polyester, epoxy, carbon or glass reinforced epoxy, polydimethylsiloxane, urethane, polyurethane, silicone, and elastomers. This material 114 may be deposited by a nozzle, or may be vacuum-cast, or formed with other practices common in the industry. This material 114 is held in the vicinity of the electro-optical module 105 by the cavity shape of the rigid layer 102. Input/output leads 116 extending from the electro-optic module 108 for contacting module driver circuitry 116 extend away from the adhesive material 112, 114 so that they remain available for electrical contact. A portion of the electro-optic module 105 may be transparent to allow the passage of light from a light source, for example, a liquid crystal display, a light emitting diode, an organic light emitting device, and a transmissive light emitting diode display. In regions where the passage of light from the electro-optical module 105 is required, adhesive material 114 will be transparent and have high optical quality, and preferably have a refractive index that is well-matched to the electro-optical module 105. The adhesive material 112 and 114 are cured simultaneously. A thermal or catalytic cure often requires between 10 minutes and 10 hours. Ultra-violet light and related cures, which are often more expensive, require as little as 30 seconds. Curing can be accomplished in batch processes with thousands of housing units, thereby eliminating the extra cost per part associated with the longer cure times.

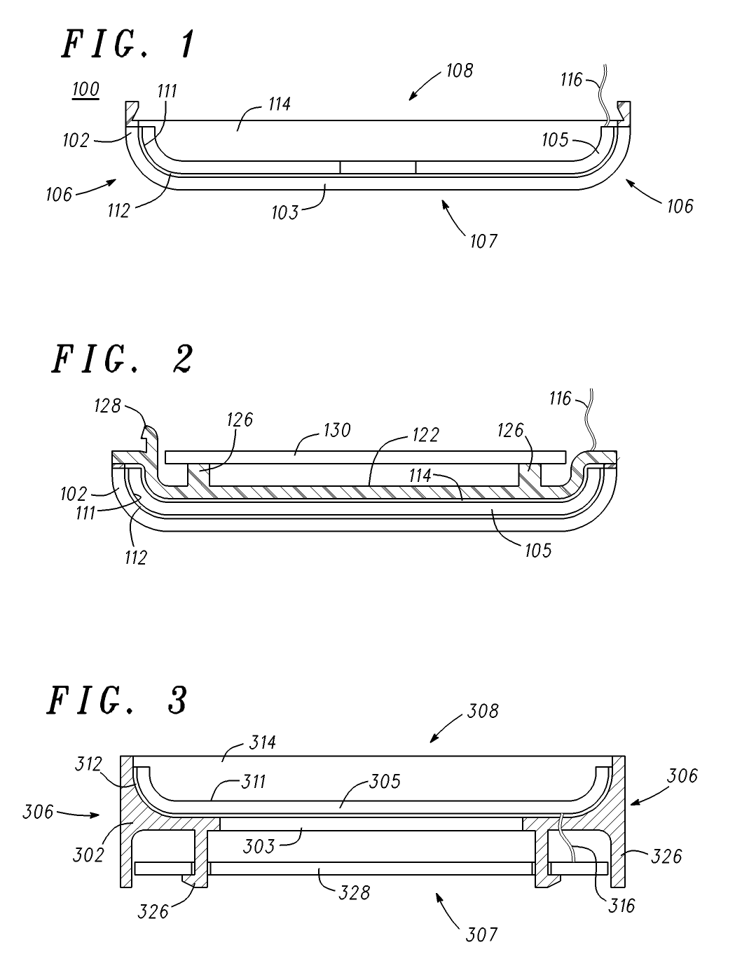

Referring to FIG. 2, an inner support structure 122 is provided as an additional to the embodiment in FIG. 1. The inner support structure 122 is positioned on side 124 of the adhesive 114 opposed to the electro-optical module 105. The inner support structure 122 is preferably a rigid material, for example, a low cost injection-molded polycarbonate material fabricated at temperatures above the limits for the electro-optical modules, for example, above 300° C., but may be fabricated using other methods. The inner support structure 122 may comprise a protrusion 126 defining an orifice for receiving a bolt or screw for securing a circuit board 130, for example, to the inner support structure 122. The inner support structure 122 may comprise pins 128 or cavities which connect to additional structures (not shown) with a snap-on process and may be transparent to allow light to pass through from a light source, e.g., a liquid crystal display, on the circuit board 130 to the electro-optic module 105. The inner support structure 122 may be adhered to adhesive 114 by the method of being placed in contact with the adhesive 114 in its uncured state, thereby forming an adhesive bond that remains upon curing of adhesive 114. The inner support structure 122 may also be adhered to adhesive 114 or the rigid plate 102 by means of curable adhesive, tapes, foam adhesives, snap-on processes (with mating features on rigid shell 102), screws, or other methods common in electronic device manufacture.

Referring to FIG. 3 and in accordance with a second exemplary embodiment, a rigid support layer 302 (inner protective structure) is provided. The rigid layer 302 is preferably fabricated under conditions of temperature and pressure that are too extreme for the electro-optical module 305. The support structure 302 may be formed from stamped or cast metal, or it may be injection-molded with a polycarbonate at a temperature, for example, greater than 300° C., but may be molded using other methods and may include insert-molded elements, particularly metal frames for structural support. In this embodiment, the rigid layer 302 will become a rear support layer for the electro-optical module 305, so it can be opaque, except in regions 303 where light is designed to pass from the circuit board 328 to the electro-optical module 305. The sides 306 of the rigid layer 302 are out of plane with the rigid layer center 307, thereby forming a concave shape or cavity 308. As an example, FIG. 3 shows an essentially flat center region 307, with sidewalls 306 at the edge that define the cavity 308. The cavity 308 enables the rigid layer 302 to acts as the mold for curable adhesive or resin in later steps. The rigid layer 302 is molded to form a curvature having a radius of less than approximately 1.0 centimeter. The attachment apparatus 326 includes attachment apparatus 326 for affixing additional electronic circuit elements 328. The inner support structure 302 may comprise a protrusion defining an orifice for receiving a bolt or screw for securing a circuit board, for example, to the inner support structure 302. The inner support structure 302 may comprise pins or cavities which connect to additional structures with a snap-on process.

In FIG. 3, an electro-optical module 305 is positioned on, e.g, conformally fitted, the adhesive 312 with the viewable surface 311 opposed to the inner support layer 302. The electo-optical module 305 preferably is formed on a polymeric substrate and preferably comprises one of a cholesteric liquid crystal module, an electrowetting module, an electrochromic module, or an electrophoretic module for low power applications, or a polymer dispersed liquid crystal module or a twisted nematic liquid crystal module for higher power applications. The electro-optical module 305 has segmented or fully addressable regions for displaying information in the preferred embodiment. The electro-optical module 305 contains flexible substrates which create a very thin module suitable for housing. For cases where the electro-optical module 305 will be positioned over curves in the rigid layer 302, the flexible substrates allow for the electro-optical module 305 to be mechanically conformed to the curves in the rigid layer 302. Alternatively, the electro-optical module 305 may be thermoformed to the curvature of the rigid layer 302 during the when it is positioned, or it can already contain a curved profile. A touch screen (not shown) may positioned overlying the electro-optical module 305 and may be connected to the electro-optical module 305 with adhesive, forming an electro-optical module stack.

An adhesive material 312, for example an optical adhesive, cast resin, or curable polymer is optionally deposited on the rigid layer 302 within the cavity 308 before placement of the electro-optic module 305 by a nozzle (not shown) or any appropriate method known in the industry. For regions where the electro-optical module 305 is designed to transmit light, the adhesive 312 preferably has a good refractive index match to the electro-optical module 305. Alternatively, the electro-optical module 305 may be vacuum-cast (in the next step) into the housing 302 without the adhesive 112. A vacuum removes the gas which would otherwise form bubbles between the rigid layer 302 and the electro-optical module 305, and the cast material holds the module 305 in place.

Another adhesive material 314, for example, an optical adhesive, cast resin, or curable polymer, is deposited on the electro-optical module or electro-optical module stack 305. The adhesive 314 is in contact with the viewable surface 311 of the electro-optical module 305 and is transparent in regions where the viewable surface 311 is designed to be observed. It is preferable that the adhesive 314 have a good refractive index match with the electro-optical module 305. Adhesive 314 functions as the outer protective layer for the electro-optical module 305, and as such, it is hard, scratch-resistant, and thicker than 50 micrometers to repel deep scratch damage. This adhesive material 314 may be deposited by a nozzle, or may be vacuum-cast, or formed with other practices common in the industry. This adhesive material 314 is held in the vicinity of the electro-optical module 305 by the cavity shape of the rigid layer 302. Input/output leads 316 extending from the electro-optic module 305 for contacting module driver circuitry 328 preferably extend under the back of the electro-optical module 305 and through a slit (not shown) in the inner support layer 302. A plate or tape covering the slit prevents the adhesive material 312 from contacting the electrical leads 316 so that they remain available for electrical contact. The adhesive materials 312 and 314 are cured. A thermal or catalytic cure often requires between 10 minutes and 10 hours. Ultra-violet light and related cures, often more expensive, can require as little as 30 seconds. Curing can be accomplished in batch processes with thousands of housing units, thereby eliminating the extra cost per part associated with the longer cure times. An optional hardcoat material (not shown) may be deposited on the outer surface of the adhesive 314 to improve mechanical durability.

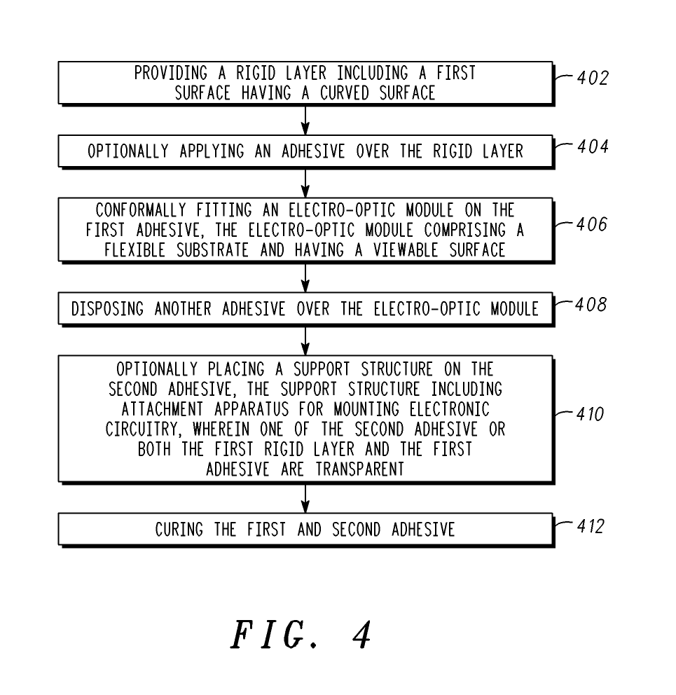

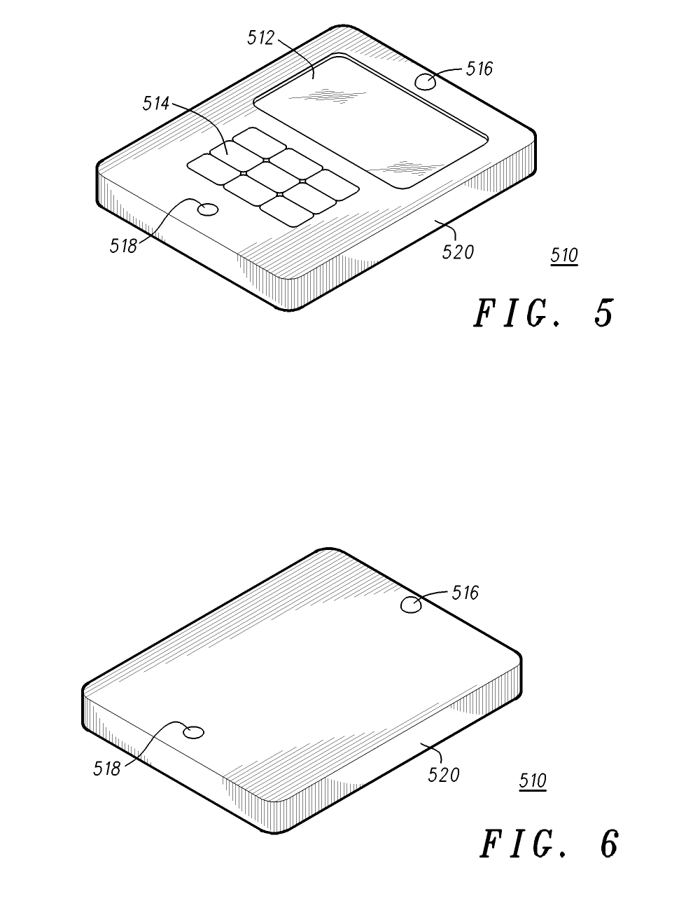

FIG. 4 is a flow chart of the steps of the method described herein. A first rigid layer including a first surface having a curved surface is provided 402. A first adhesive is optionally applied 404 over the rigid layer and an electro-optic module, comprising a flexible substrate and having a viewable surface, is conformally fitted 406 over the electro-optic module (or the first optional adhesive). A second optional adhesive is disposed 408 over the electro-optical module. In a second embodiment, a support structure, including attachments for mounting electronic circuitry, may be disposed 410 on the second adhesive. One of the second adhesive or both the first rigid layer and the first adhesive are transparent. The first and second adhesives are cured 412 simultaneously.

FIG. 5 shows in schematic form a mobile communication device, which may be used with the exemplary embodiments of a portable electronic device 510 described herein, and includes a display 512, a control panel 514, a speaker 516, and a microphone 518 formed within a housing 520. Conventional mobile communication devices also include, for example, an antenna and other inputs which are omitted from the figure for simplicity. Circuitry (not shown) is coupled to each of the display 512, control panel 514, speaker 516, and microphone 518. It is also noted that the portable electronic device 510 may comprise a variety of form factors, for example, a “foldable” cell phone. While this embodiment is a portable mobile communication device, the present invention may be incorporated within any electronic device having a housing that incorporates an electro-optical module to change colors and/or patterns. Other portable applications include, for example, a laptop computer, personal digital assistant (PDA), digital camera, or a music playback device (e.g., MP3 player). Non-portable applications include, for example, car radios, stainless steel refrigerators, watches, and stereo systems. The low power requirements exemplary embodiments presented herein make them particularly well suited to portable electronics devices. Typically, they consume less than 1 microwatt per centimeter squared of device area. They can cover entire surfaces of most portable electronic devices in full actuation, without draining significant battery power between charges.

The structure 100 of FIGS. 1 and 2 may be used for the housing 520 of FIG. 5 with the viewable surface of the electro-optical module forming part of the look of the portable electronics device. With the electro-optical module connected to appropriate control circuitry and software, the appearance of the phone can be modified in response to stimuli including external sensors, phone signal levels, caller identity, etc. The user may also personalize the portable electronic device by changing the colors and patterns presented on the electro-optical module. In the case where the electro-optical modules can display characters and icons, the housing can also communicate information

In another embodiment shown in FIG. 6, the structure 100 may also cover the input panel 514 and/or the display 512. A portion of the electro-optical module 105, 305 may be selectively made transparent to make visible the input panel 514 and display 512.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for forming a housing for an electronic device, comprising:
providing a first rigid layer including a first surface having a curved surface;
conformally fitting an electro-optical module on the curved surface, the electro-optical module comprising a flexible substrate and having a viewable surface;
disposing a first adhesive over the electro-optical module; and
curing the first adhesive, wherein one of the rigid layer or the first adhesive are transparent adjacent the viewable surface.

2. The method of claim 1, when the first rigid layer is transparent, further comprising:
disposing a second rigid layer over the first adhesive; and
securing circuitry to attachment points on the second rigid layer.

3. The method of claim 2 wherein the conformally fitting step comprises:
conformally fitting an electro-optical module having a display as the viewable surface.

4. The method of claim 1 further comprising disposing a second adhesive between the rigid layer and the electro-optical module, and wherein the curing step includes curing the second adhesive.

5. A method for manufacturing a plurality of electronic device housings, comprising:
providing a rigid layer defining a cavity for each of the housings;
placing one of a plurality of electro-optical modules on each of the rigid layers and within the cavity associated with each electro-optical module, each of the electro-optical modules comprising a flexible substrate;
disposing a first adhesive within each of the cavities and over each of the electro-optical modules; and
curing the first adhesive overlying the plurality of electro-optical modules in a single batch.

6. A method for forming a housing for an electronic device, comprising:
providing a first rigid layer defining a cavity;
placing an electro-optical module on the first rigid layer and within the cavity, the electro-optical module comprising a flexible substrate;
disposing a first adhesive within the cavity and over the electro-optical module; and
curing the first adhesive.

7. The method of claim 6 further comprising disposing a second adhesive between the first rigid layer and the electro-optical module, and wherein the curing step includes curing the second adhesive.

8. The method of claim 6 wherein the providing step comprises providing a first rigid layer having a transparent portion, wherein the electro-optical module includes a viewing area viewable through the transparent portion.

9. The method of claim 8 wherein the disposing step comprises disposing a first transparent adhesive.

10. The method of claim 8 further comprising placing a second rigid layer on one of the first adhesive and the first rigid layer, and having attachment points.

11. The method of claim 6 wherein the placing step comprises placing the electro-optical module includes a viewing area on a side opposed to the rigid layer, and the disposing step comprises disposing a first adhesive that is transparent.

12. The method of claim 11 wherein the placing step comprises providing a plurality of electrical leads extending through the rigid layer.

13. The method of claim 11 wherein the providing step comprises providing the rigid layer having attachment points attached to electronic circuitry.

14. The method of claim 11 wherein the disposing step comprising disposing a first adhesive having a thickness greater than 50 micrometers.

15. The method of claim 6 wherein the placing step comprising providing a plurality of electrical leads extending from the first adhesive.

16. The method of claim 6 wherein the placing step comprises placing the electro-optical module having a melting temperature of less than 250 degrees C.

17. The method of claim 6 wherein the providing step comprises providing a rigid layer having a curved portion defining the cavity and the electro-optical module is conformally fitted within the curved portion.

18. The method of claim 6 wherein the placing step comprises placing an electro-optical module that comprises an organic shape.
